(19) United States
(12) Patent Application Publication
(10) Pub. No.: US 2024/0176466 A1
(43) Pub. Date: May 30, 2024

(54) CONTENT SHARING METHOD AND ELECTRONIC DEVICE

(71) Applicant: BEIJING DAJIA INTERNET INFORMATION TECHNOLOGY CO., LTD., Beijing (CN)

(72) Inventor: Shiyuan TAO, Beijing (CN)

(21) Appl. No.: 18/510,249

(22) Filed: Nov. 15, 2023

(30) Foreign Application Priority Data
Nov. 29, 2022 (CN) 202211517797.3

(51) Int. Cl. G06F 3/0484; G06F 3/0482; H04L 67/306

(52) U.S. Cl. CPC G06F 3/0484; G06F 3/0482; H04L 67/306; G06Q 50/01

(57) ABSTRACT

A content sharing method applied to a first user terminal of a first user account is provided. The method includes: displaying a sharing page in response to a sharing operation performed to displayed target social content; and generating a sharing instruction in response to a triggering operation performed to the target control. The sharing page comprises a target control and the target control is configured to be triggered to share social content to an associated user account, and the sharing instruction is used to instruct to recommend the target social content to a second user account which has established an account association relationship with the first user account.

### CROSS-REFERENCE TO RELATED APPLICATIONS

This application is based on and claims priority to Chinese Patent Application No. 202211517797.3, filed on Nov. 29, 2022, the present disclosure of which is herein incorporated by reference in its entirety.

### TECHNICAL FIELD

The present disclosure relates to the field of computer technologies, and in particular, to a content sharing method and apparatus.

### BACKGROUND OF THE INVENTION

As the functions of social media applications become increasingly rich, social media applications allow users to share social content with other users, in which the social content may be text content, graphic content or video content.

### SUMMARY OF THE INVENTION

The present disclosure provides a content sharing method and apparatus.

According to an aspect of an embodiment of the present disclosure, a content sharing method is provided. The method is applied to a first user terminal which is a terminal device of a first user account. The method includes:
displaying a sharing page in response to a sharing operation performed to displayed target social content, where the sharing page includes a target control and the target control is configured to be triggered to share social content to an associated user account; and
generating a sharing instruction in response to a triggering operation performed to the target control, where the sharing instruction is used to instruct to recommend the target social content to a second user account which has established an account association relationship with the first user account.

According to another aspect of the embodiment of the present disclosure, a content sharing method is provided. The method is applied to a second user terminal which is a terminal device of a second user account. The method includes:
determining content to be displayed in response to a content display operation; and
displaying a target social content including type prompt information on a second page, in a case that the content to be displayed includes the target social content determined according to a sharing instruction, where the sharing instruction is generated by a first user terminal which is a terminal device of a first user account and is used to instruct to recommend the target social content to the second user account which has established an account association relationship with the first user account, and the type prompt information is used to prompt that the target social content is social content recommended by a user account with account association.

According to another aspect of an embodiment of the present disclosure, an electronic device is provided. The electronic device includes:
a processor; and
a memory for storing instructions executable by the processor;
the processor is configured to execute the instructions to implement the following steps:
displaying a sharing page in response to a sharing operation performed to displayed target social content, where the sharing page includes a target control and the target control is configured to be triggered to share social content to an associated user account; and generating a sharing instruction in response to a triggering operation performed to the target control, where the sharing instruction is used to instruct to recommend the target social content to a second user account which has established an account association relationship with the first user account; or,
determining content to be displayed in response to a content display operation; and
displaying a target social content including type prompt information on a second page, in a case that the content to be displayed comprises the target social content determined according to a sharing instruction, where the sharing instruction is generated by a first user terminal which is a terminal device of a first user account and is used to instruct to recommend the target social content to the second user account which has established an account association relationship with the first user account, and the type prompt information is used to prompt that the target social content is social content recommended by a user account with account association.

According to another aspect of an embodiment of the present disclosure, a computer-readable storage medium is provided, which when instructions in the computer-readable storage medium are executed by a processor of an electronic device, enables the electronic device to perform the following steps:
displaying a sharing page in response to a sharing operation performed to displayed target social content, where the sharing page includes a target control and the target control is configured to be triggered to share social content to an associated user account; and generating a sharing instruction in response to a triggering operation performed to the target control, where the sharing instruction is used to instruct to recommend the target social content to a second user account which has established an account association relationship with the first user account; or,
determining content to be displayed in response to a content display operation; and
displaying a target social content including type prompt information on a second page, in a case that the content to be displayed comprises the target social content determined according to a sharing instruction, where the sharing instruction is generated by a first user terminal which is a terminal device of a first user account and is used to instruct to recommend the target social content to the second user account which has established an account association relationship with the first user account, and the type prompt information is used to prompt that the target social content is social content recommended by a user account with account association.

### BRIEF DESCRIPTION OF DRAWINGS

The drawings herein are incorporated into and constitute a part of this specification, illustrate embodiments consistent with the present disclosure, and together with the description are used to explain the principles of the present disclosure, and do not constitute undue limitations on the present disclosure.

FIG. 1 is a schematic architecture diagram of a social content sharing system which is illustrated according to some embodiments;

FIG. 2 is a flow chart of a content sharing method which is illustrated according to some embodiments;

FIG. 3 is a page prompting that an account association relationship is successfully established, and the page is illustrated according to some embodiments;

FIG. 4 is a function explanation information display page which is illustrated according to some embodiments;

FIG. 5 is a second page according to an exemplary embodiment;

FIG. 6 is a sharing page which is illustrated according to some embodiments;

FIG. 7 is a first page which is illustrated according to some embodiments;

FIG. 8 is another second page which is illustrated according to some embodiments;

FIG. 9 is another second page which is illustrated according to some embodiments;

FIG. 10 is another second page which is illustrated according to some embodiments;

FIG. 11 is another second page which is illustrated according to some embodiments;

FIG. 12 is another second page which is illustrated according to some embodiments;

FIG. 13 is a message preview page which is illustrated according to some embodiments;

FIG. 14 is a flow chart of another content sharing method which is illustrated according to some embodiments;

FIG. 15 is a block diagram of a social content sharing apparatus which is illustrated according to some embodiments;

FIG. 16 is a block diagram of another social content sharing apparatus which is illustrated according to some embodiments; and

FIG. 17 is a block diagram of an electronic device which is illustrated according to some embodiments.

### DETAILED DESCRIPTION

In order to allow ordinary people in the art to better understand the technical solutions of the present disclosure, the technical solutions in the embodiments of the present disclosure will be clearly and completely described below in conjunction with the accompanying drawings.

It should be noted that the terms “first”, “second”, etc. in the description and claims of the present disclosure and the above-mentioned drawings are used to distinguish similar objects and are not necessarily intended to describe a specific order or sequence. It is to be understood that the data so used are interchangeable under appropriate circumstances so that the embodiments of the present disclosure described herein can be practiced in sequences other than those illustrated or described herein. The implementations described in the following exemplary embodiments do not represent all implementations consistent with the present disclosure. Rather, they are merely examples of apparatus and methods consistent with aspects of the present disclosure as detailed in the appended claims.

In the related art, when a user wants to share social content in a social media application, he/she can share the social content with other users through a third-party conversation platform or through a private message channel provided by the social media application.

When a user shares social content through a third-party conversation platform, he/she needs to trigger a user terminal to display a sharing channel display page, select a trigger control of the third-party conversation platform in the sharing channel display page to jump to a conversational interface of the third-party conversation platform, and share the social content that needs to be shared in the form of third-party conversational content. For a recommended user, he/she needs to open an application such as a social media application to view the recommended social content after obtaining the recommended information on the third-party conversation interface.

Or, in the process of a user sharing social content through a private message channel provided by a social media application, after the user triggers a user terminal to display a sharing channel display page, the user selects a target user among a plurality of mutually following user accounts displayed on the sharing channel display page to share the social content, then a conversation page with the target user is displayed, and the social content that needs to be shared is shared in a private message. For a recommended user, the recommended user needs to view the private message content and view the recommended content on a message display interface of a social media application.

It can be seen that in the content sharing method in the related art, the operation process of sharing social content and the process of viewing shared user's social content are all relatively complicated, and the user experience of users sharing social content is poor.

In view of the above problems, a content sharing method is provided according to exemplary embodiments of the present disclosure. Application scenarios of the content sharing method include but are not limited to: a first user account of a first user terminal may establish an account association relationship with a second user account of a second user terminal, and when the first user account needs to share social content, the first user terminal displays a sharing page in response to a sharing operation performed to displayed target social content; and generates a sharing instruction in response to a triggering operation on a target control, in which the sharing page includes a target control, which is a trigger control for sharing social content to an associated user account, and the sharing instruction is used to instruct to recommend the target social content to the second user account that has established an account association relationship with the first user account.

The second user terminal determines content to be displayed in response to a content display operation; and when the content to be displayed includes target social content determined according to a first sharing instruction, the second user terminal displays the target social content including type prompt information on a second page. The second user account is a user account that has established an account association relationship with the first user account, and the type prompt information is used to prompt that the target social content is social content recommended by a user account with an account association relationship. It can realize one-click sharing of social content, reduce the operation procedures in the process of sharing social content, and improve the user experience.

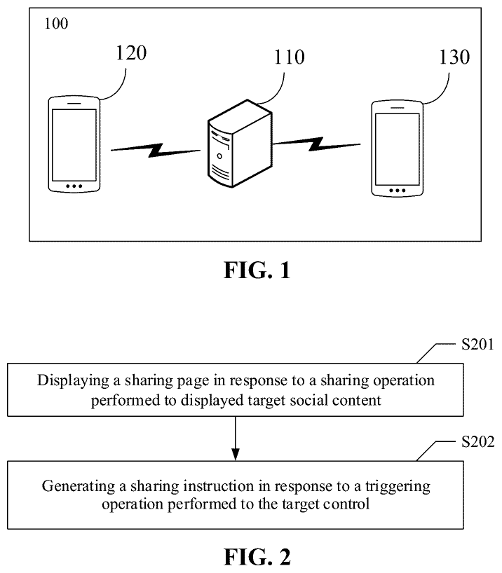

In order to implement the above content sharing method, a social content sharing system is provided according to an exemplary embodiment of the present disclosure. FIG. 1 shows a schematic architecture diagram of the social content sharing system. As shown in FIG. 1, the social content sharing system 100 may include a server 110, a first user terminal 120 and a second user terminal 130. The server 110 may be a backend server deployed by a social content service provider. The social content service provider may be a short video platform service provider, a music platform service provider, a shopping platform service provider, etc. The first user terminal 120 and the second user terminal 130 are terminal devices or electronic device used by users. More specifically, the terminal devices may be smart phones, personal computers, tablet computers, etc. The server 110 and the terminal device 120 may establish a connection over network to realize social content sharing. An application provided by the server 110 is installed in the terminal device, and the user can view social content through the application. The application may be a social media application.

It should be understood that the server 110 may be one server or a cluster formed by a plurality of servers. The specific architecture of the server 110 is not limited in the present disclosure.

FIG. 2 is a flow chart of a content sharing method which is illustrated according to some embodiments. As shown in FIG. 2, the content sharing method is applied to a first user terminal which is a terminal device of a first user account and is installed with a social media application. The content sharing method includes the following steps.

In step S201, a sharing page is displayed in response to a sharing operation performed to displayed target social content.

In the embodiment of the present disclosure, the sharing page is a page of a social media application. The target social content is displayed on a social content display page in the first user terminal, and the social content display page includes a content sharing control. The sharing operation is performed by a first user on the content sharing control. The sharing page includes a target social content, and a target control which is a trigger control for sharing social content to an associated user account. That is, the target control is configured to be triggered to share the social content to an associated user account when it is triggered by the first user of the first user account. The associated user account refers to a user account that has established an account association relationship with the first user account.

In step S202, a sharing instruction is generated in response to a triggering operation performed on the target control.

In an embodiment of the present disclosure, the sharing instruction is used to instruct to recommend the target social content to a second user account that has established an account association relationship with the first user account.

In summary, in the content sharing method according to the embodiment of present disclosure, a sharing page may be displayed in response to a sharing operation performed to displayed target social content, and a sharing instruction may be generated in response to a triggering operation on a target control in the sharing page. The sharing instruction is used to instruct to recommend the target social content to a second user account that has established an account association with a first user account. By means of the triggering operation performed to the target control, the target social content is directly shared to a user account that has established an account association, which reduces the user operation procedures during the social content sharing process, improves the convenience of social content sharing, and improves the user's social content sharing experience.

The steps in FIG. 2 are described in detail below.

In the above step S201, the first user terminal may display the sharing page in response to the sharing operation performed to the displayed target social content.

In an embodiment of the present disclosure, the sharing page may display trigger controls for a plurality of sharing channels. The sharing channels may include trigger controls of third-party platforms, a user account that follows each other with the first user account, a target control etc. The target control is a trigger control for sharing social content to the associated user account.

It should be noted that in the embodiment of the present disclosure, if the user wants to share social content through the target control, he/she needs to establish an account association relationship first. Therefore, before the first user terminal displays the sharing page in response to the sharing operation of the displayed target social content, it needs to send a relationship establishment request to the second user terminal, and the second user terminal displays a page prompting that the account association relationship is successfully established in response to obtaining an establishment consent operation for the account association relationship. Optionally, after an account association relationship is established among user accounts, whether to receive social content recommended by an associated user account may be set, so that the social content recommended by the associated user account can be received or refused based on the user's actual choice.

It can be understood that the process of the first user terminal sending the relationship establishment request to the second user terminal may include: the first user terminal sends the relationship establishment request regarding the second user account to a server, and the server determines the second user terminal based on the second user account and sends the relationship establishment request to the second user terminal. The second user terminal is the terminal device of the second user account.

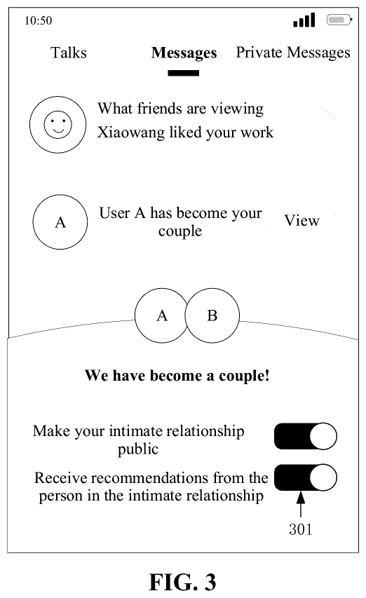

In some embodiments, taking a server as a short video platform server as an example, after a first user account A sends a relationship establishment request regarding a second user account B to the server through a first user terminal, the server of the short video platform may send a relationship establishment request to a second user terminal according to the second user account B. When the second user terminal obtains an establishment consent operation, by a second user (i.e., User B), on an account association relationship, the second user terminal displays a page as shown in FIG. 3 which is an acknowledge page that acknowledges the successful establishment of the account association relationship. The page includes a prompt message indicating that the account association relationship between the first user account A and the second user account B is successfully established: “We have become a couple”, and an acceptance control or a control button 301 configured for the second user to determine whether to receive social content recommended by the associated user account. When the control button 301 is in a turn-on state, it indicates that the second user account B agrees to receive the social content recommended by the first user account A. When the acceptance control is on a turn-off state, it indicates that second user account refuses to receive the social content recommended by the first user account. The server is informed of a state of the acceptance control.

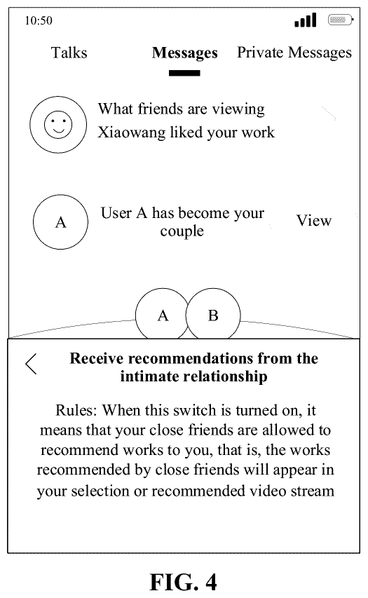

In some embodiments, after the second user account B selects to turn on the control button 301, the function explanation information after turning on the control button 301 may be displayed, as shown in FIG. 4. In the illustrated example, the function explanation information is “Rule: When this switch is turned on, it means that your close friends are allowed to recommend works to you, that is, the works recommended by close friends will appear in your selection or recommended video stream.”

In some embodiments, the process of the first user terminal displaying the sharing page in response to the sharing operation performed to the displayed target social content may include: in the process of displaying the social content through a social media application on the first user terminal, when the target social content is displayed on a social content display page, if a triggering operation on a content sharing control on the social content display page is detected, it is determined that the sharing operation performed to the displayed target social content is obtained, and the sharing page is displayed. The social content display page is a page displayed on the first user terminal.

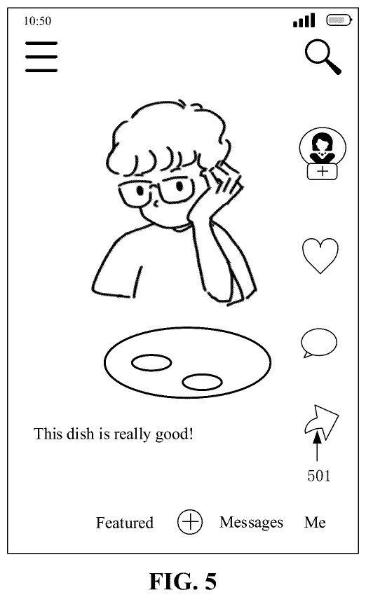

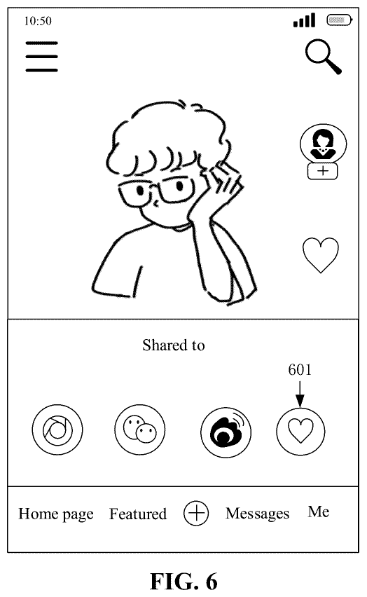

In some embodiments, the social content display page of the first user terminal is as shown in FIG. 5. The displayed target social content is Xiaohong's video content. If a triggering operation on a content sharing control 501 is detected, and the sharing page as shown in FIG. 6 is displayed. The first user of the first user terminal may perform a sharing operation by triggering the content sharing control. The sharing page includes a target control 601.

In the above step S201, the first user terminal may generate the sharing instruction in response to the triggering operation performed on the target control.

In an embodiment of the present disclosure, the sharing instruction is used to instruct to recommend the target social content to the second user account. That is, the sharing instruction is used to instruct to recommend the target social content to the second user account that has established an account association relationship with the first user account. A plurality of second user accounts may establish an account association relationship with the first user account.

In some embodiments, the process of the first user terminal generating the sharing instruction in response to the triggering operation performed to the target control may include generating a first sharing instruction in response to the triggering operation performed to the target control. The first sharing instruction is used to instruct to recommend the target social content to a plurality of second user accounts. Optionally, the plurality of second user accounts are all second user accounts that have established an account association relationship with the first user account. Correspondingly, the first sharing instruction is used to instruct to recommend the target social content to all second user accounts that have established an account association relationship with the first user account, thereby improving the convenience and efficiency of recommending social content to the second user accounts.

In some embodiments, the process of the first user terminal generating the sharing instruction in response to the triggering operation performed to the target control may include: displaying a first page in response to the triggering operation performed to the target control, the first page including a plurality of second user accounts; generating a second sharing instruction in response to a selection operation performed to at least one second user account among the plurality of second user accounts, the second sharing instruction being used to instruct to recommend the target social content to the at least one second user account selected by the selection operation. By recommending the target social content to the at least one selected second user account among all second user accounts that have established an account association relationship with the first user account, the user's need to recommend target content to a target second user account can be satisfied and personalized recommendation of social content can be achieved, thereby improving the accuracy of recommendations.

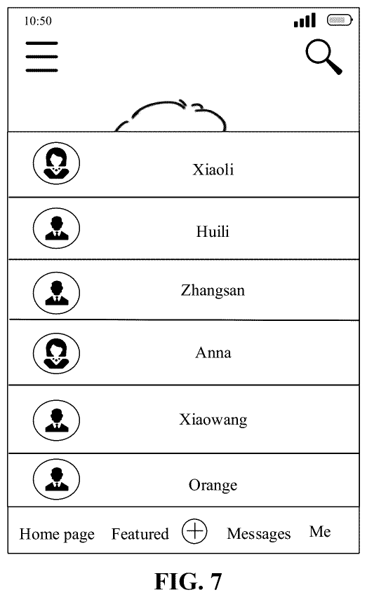

For example, the first user terminal displays the first page as shown in FIG. 7 in response to the triggering operation performed to the target control. The second user accounts that have established an account association relationship with the first user account may include: Xiao Li, Huili, Zhang San, Anna, Xiao Wang, Orange, etc. When the first user terminal detects a selection operation on Xiao Wang and Orange, the first user terminal generates a second sharing instruction. The second sharing instruction is used to instruct to recommend the target social content to Xiao Wang and Orange.

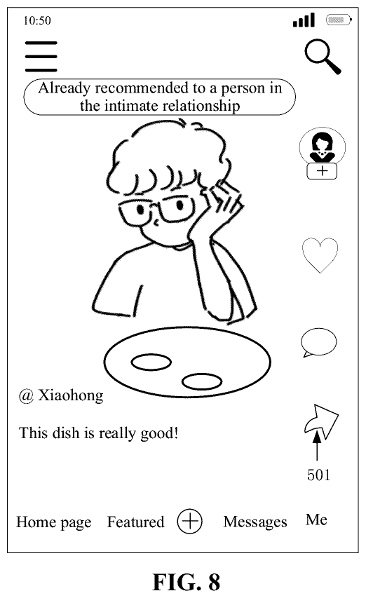

In some embodiments, after the first user terminal generates the sharing instruction, third prompt information may also be displayed. The third prompt information is used to prompt that the target social content has been recommended to the second user account. By displaying the third prompt information, it is convenient for a recommending user account to intuitively determine that social content recommended by it has been recommended, thereby improving the user's social content recommendation experience. As shown in FIG. 8, FIG. 8 shows a schematic diagram of a second page displayed in the first user terminal. The second page is the social content display page updated after the sharing instruction is sent, that is, the second page is an updated social content display page. The second page displays information after the sharing instruction is generated, including the displayed social content and the third prompt information: “Already recommended to a person in the intimate relationship.”

It should be noted that in the embodiment of the present disclosure, after the first user terminal generates the sharing instruction, it can send the sharing instruction to a server, and the server sends the sharing instruction to the second user terminal, so as to achieve the purpose of the server instructing or controlling the second user terminal to display the target social content.

In some embodiments, when the sharing instruction is a first sharing instruction, the server may parse the first sharing instruction to obtain the first user account and the identification information of target social content. Correspondingly, the process of the server instructing the second user terminal to display the target social content may include: determining a second user account that has established an account association relationship with the first user account based on the first user account and account relationship information. When it is determined that the second user account that has established an account association relationship with the first user account refuses to receive videos recommended by the first user account, after determining that the second user terminal of the second user account is connected to the server, social content posted by a user account having an account association relationship with the second user account is determined as content to be displayed, and the content to be displayed is sent to the second user terminal.

When it is determined that the second user account that has established an account association relationship with the first user account agrees to receive videos recommended by the first user account, after it is determined that the second user terminal is connected to the server, the target social content corresponding to the identification information of the target social content and/or social content posted by a user account having an account association relationship with the second user account is determined as content to be displayed, and the content to be displayed is sent to the second user terminal. The account relationship information is determined by the server after the server determines that the first user account and the second user account have successfully established an account association relationship.

In some embodiments, when the sharing instruction is a second sharing instruction, the server may parse the second sharing instruction to obtain the first user account, identification information of the target social content, and the at least one second user account selected by the selection operation. The process of the server instructing the second user terminal to display the target social content may include: for any second user account selected by the selection operation, if it is determined that the second user account refuses to receive videos recommended by the first user account, after determining that the terminal device of the second user account, that is, the second user terminal is connected to the server, social content posted by a user account having an account association relationship with the second user account is determined as content to be displayed, and the content to be displayed is sent to the second user terminal.

When it is determined that the second user account agrees to receive videos recommended by the first user account, after determining that the terminal device of the second user account, that is, the second user terminal is connected to the server, the target social content corresponding to the identification information of the target social content and/or social content posted by a user account having an account association relationship with the second user account is determined as content to be displayed, and the content to be displayed is sent to the second user terminal.

In some embodiments, for the content sharing method performed by the first user terminal, the sharing instruction is sent, by the server, to the second user terminal and the target social content is determined as content to be displayed in the case that the server determines that a second user account that has established an account association relationship with the first user account based on the first user account and account relationship information while the second user terminal is connected to the server, and wherein the content to be displayed is displayed as the target social content on a social content sharing page of the second user terminal in response to a content display operation performed to the second user terminal.

In some embodiments, for the content sharing method performed by the second user terminal, the server is configured to determine a second user account that has established an account association relationship with the first user account based on the first user account and account relationship information, and after determining that the second user terminal of the second user account is connected to the server, determine social content posted by a user account having an account association relationship with the second user account as content to be displayed, and send the content to be displayed to the second user terminal, the method further comprising: displaying the content to be displayed as the target social content in response to a content display operation, and upon determination that the content to be displayed includes the target social content according to the sharing instruction.

In some embodiments, the second user terminal may determine the content to be displayed in response to a content display operation. If the content to be displayed includes the target social content determined according to the first sharing instruction, the target social content including type prompt information is displayed on the second page. The type prompt information is used to prompt that the target social content is social content recommended by a user account with an account association relationship. By directly displaying recommended target social content on a terminal device of a recommended user account, and prompting that the target social content is content recommended by the user account's associated user account, the recommended user account can view the recommended target social content without additional operating procedures, thereby improving users' social content viewing experience.

In some embodiments, the process of the second user terminal determining the content to be displayed in response to the content display operation may include: after the second user terminal obtains running feedback of the social media application in the second user terminal, it may determine that the content display operation is obtained, and the second user terminal may establish a connection with the server and receive the content to be displayed sent by the server. The running feedback is a status that the social media application is being run in the second user terminal. The social media application is served by the server.

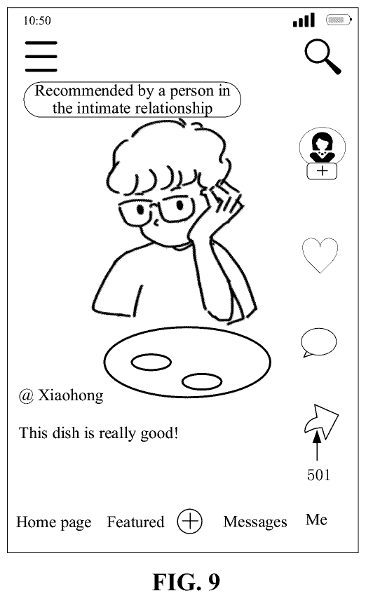

For example, as shown in FIG. 9, FIG. 9 shows a second page or a social content display page displayed by the second user terminal. The second page of the second user terminal displays the target social content recommended by the first user account. The target social content is Xiaohong's video content. The second page displayed by the second user terminal also displays type prompt information: “Recommended by a person in the intimate relationship” to prompt that Xiaohong's video content is social content recommended by a user account that has established an account association relationship with the second user account.

In some embodiments, the type prompt information may also carry account information of the first user account, and the type prompt information is also used to prompt that the target social content is social content recommended by the first user account. By prompting the user that the social content being displayed is the target social content recommended by the account-associated user account, a specific associated user account that recommends the target social content is displayed, which is convenient for the user to efficiently obtain the user account recommending the target social content.

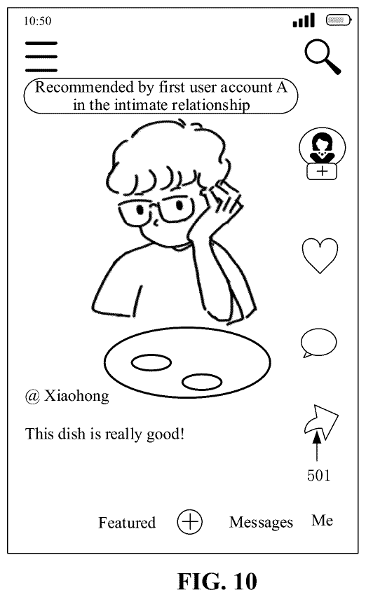

For example, the second user terminal is the terminal device of the second user account B, and the second user account B and the first user account A have established an account association relationship. As shown in FIG. 10, FIG. 10 shows a second page displayed by the second user terminal. The second page displayed by the second user terminal displays type prompt information: “Recommended by first user account A in the intimate relationship”, to prompt that Xiaohong's video content is social content recommended by the first user account A that has established an account association relationship with the second user account.

In some embodiments, after the second page of the second user terminal displays the target social content including the type prompt information, the second user terminal may also generate first prompt information and send the first prompt information to the first user terminal, so that the first user terminal displays the first prompt information. The first prompt information is used to prompt that the target social content has been viewed by a user account with an account association relationship. By generating the first prompt information after the recommended user views the recommended target social content, the user account recommending the social content is prompted that the target social content recommended by it has been viewed, so that the user account recommending the social content intuitively determines that the social content recommended by it has been viewed.

It can be understood that the process of the second user terminal sending the first prompt information to the first user terminal includes: sending the first prompt information to the server, and the server sending the first prompt information to the first user terminal.

In some embodiments, the first user terminal may display first prompt information in response to receiving the first prompt information. The first prompt information is used to prompt that the target social content has been viewed by a user account with an account association relationship. By prompting the user account recommending the social content that the target social content recommended by it has been viewed, the user account recommending the social content intuitively determines that the social content recommended by it has been viewed.

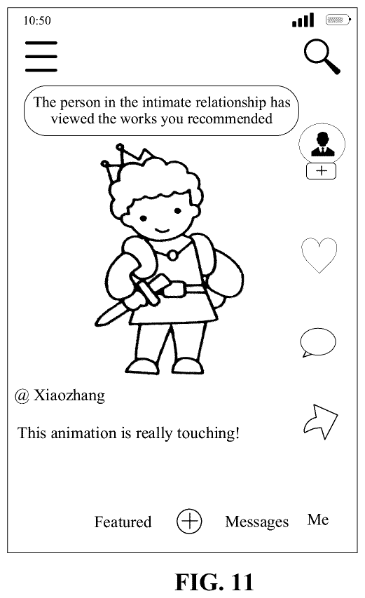

For example, FIG. 11 shows a social content display page displayed by the first user terminal. The second page displayed by the first user terminal displays social content and first prompt information: “The person in the intimate relationship has viewed works you recommended.” The first prompt information may prompt the first user account that the target social content recommended by it has been viewed by a user account that has established an account association relationship.

In some embodiments, after the second page of the second user terminal displays the target social content including the type prompt information, the second user terminal may also generate second prompt information according to the second user account, and send the second prompt information to the first user terminal, so that the first user terminal displays the second prompt information. The second prompt information is used to prompt that the target social content has been viewed by the second user account. By generating the second prompt information after the recommended user views the recommended target social content, the user account recommending the social content is prompted the specific user account which has viewed the target social content recommended by user account, so that the user account recommending the social content intuitively determines the user account which has viewed the social content recommended by it.

It can be understood that the process of the second user terminal sending the second prompt information to the first user terminal includes: sending the second prompt information to a server, and the server sending the second prompt information to the first user terminal.

In some embodiments, the first user terminal may display second prompt information in response to receiving the second prompt information. The second prompt information is used to prompt that the target social content has been viewed by the second user account. By prompting the user account recommending the social content the specific user account which has viewed the target social content recommended by it, the user account recommending the social content intuitively determines the user account that has viewed the social content recommended by it.

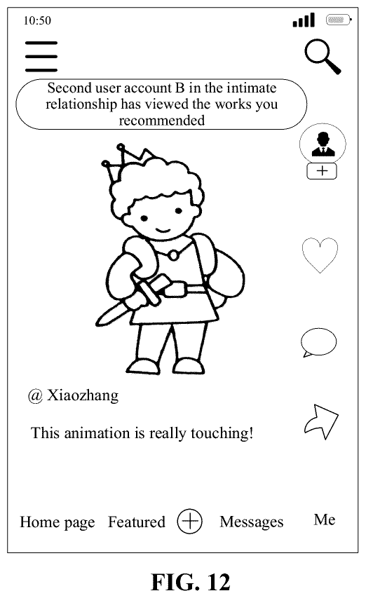

For example, FIG. 12 shows a second page displayed by the first user terminal. The second page displayed by the first user terminal displays social content and second prompt information: “The second user account B in the intimate relationship has viewed works you recommended”. The second prompt information may prompt the first user account that the recommended target social content has been viewed by the second user account B that has established an account association relationship.

In some embodiments, after the first user terminal receives the first prompt information or the second prompt information, the first user terminal may display a message preview page in response to a triggering operation on the message preview page. The message preview page includes an information preview area. The first user terminal may display the first prompt information or the second prompt information in response to a triggering operation on the information preview area. The user can view the first prompt information or the second prompt information through the message preview page, which facilitates the user to view the prompt information at any time and improves the reliability of viewing the prompt information.

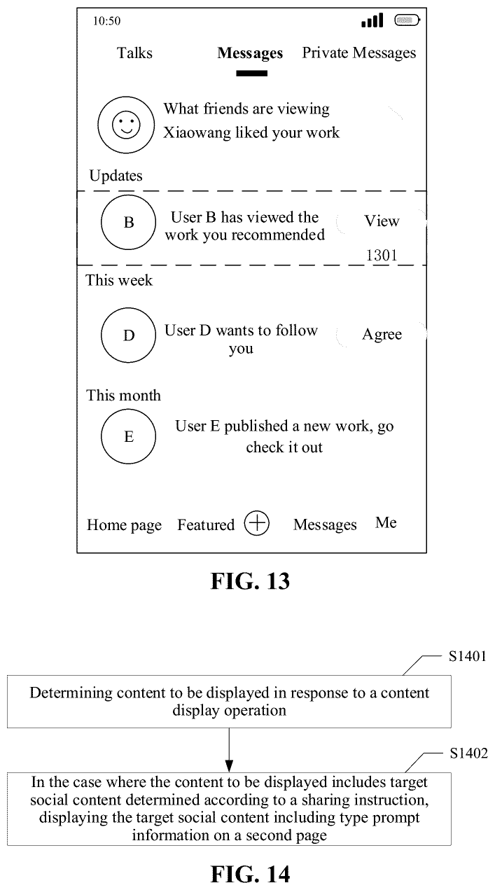

For example, FIG. 13 shows a message preview page displayed by the first user terminal. The message preview page includes an information preview area 1301. The first user terminal may display second prompt information in response to a triggering operation on the information preview area 1301. The second prompt information is “User B has viewed works you recommended.”

FIG. 14 is a flow chart of a content sharing method which is illustrated according to some embodiments. As shown in FIG. 14, the content sharing method is applied to a second user terminal. The second user terminal is a terminal device of a second user account. The content sharing method includes the following steps.

In step S1401, content to be displayed is determined in response to a content display operation.

In step S1402, when the content to be displayed includes target social content determined according to a sharing instruction, the target social content including type prompt information is displayed on a second page. The second page is a social content display page of a social media application.

In an embodiment of the present disclosure, the sharing instruction is generated by a first user terminal which is a terminal device of a first user account. The sharing instruction is used to instruct to recommend the target social content to the second user account. The second user account has established an account association relationship with the first user account. The type prompt information is used to prompt that the target social content is social content recommended by a user account with an account association relationship.

In summary, in the content sharing method according to the embodiments of the present disclosure, content to be displayed is determined in response to a content display operation, and when it is determined that the content to be displayed includes target social content determined according to a sharing instruction, the target social content including type prompt information is displayed on a second page. The above solution directly displays the recommended target social content in the recommended user terminal and prompts that the target social content is content recommended by an account-associated user account. The recommended user can view the recommended target social content without additional operation procedures, improving users' social content viewing experience.

For the process of the second user terminal determining the content to be displayed in response to the content display operation, reference can be made to the above embodiments, which will not be described in detail in the present disclosure.

In some embodiments, the type prompt information may also carry account information of the first user account, and then the type prompt information is also used to prompt that the target social content is social content recommended by the first user account.

In some embodiments, after the second page of the second user terminal displays the target social content including the type prompt information, the second user terminal may also generate first prompt information and send the first prompt information to the first user terminal, so that the first user terminal displays the first prompt information. The first prompt information is used to prompt that the target social content has been viewed by a user account with an account association relationship.

In some embodiments, after the second page of the second user terminal displays the target social content including the type prompt information, the second user terminal may also generate second prompt information according to the second user account, and send the second prompt information to the first user terminal, so that the first user terminal displays the second prompt information. The second prompt information is used to prompt that the target social content has been viewed by the second user account.

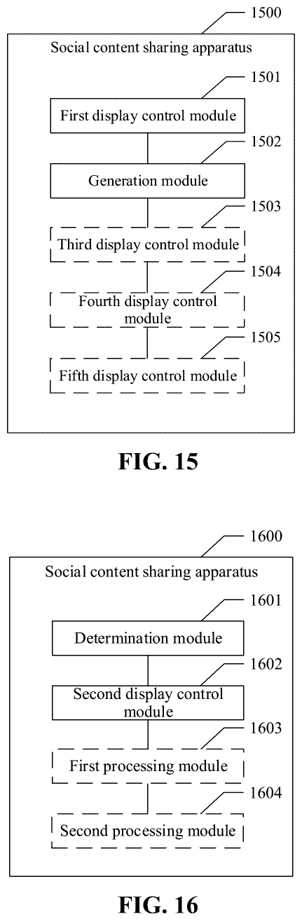

FIG. 15 is a block diagram of a social content sharing apparatus which is illustrated according to some embodiments. Referring to FIG. 15, the social content sharing apparatus is applied to a first user terminal which is a terminal device of a first user account. The social content sharing apparatus includes:
a first display control module 1501 configured to display a sharing page in response to a sharing operation performed to displayed target social content, in which the sharing page includes a target control which is configured to be triggered to share social content to an associated user account; and
a generation module 1502 configured to generate a sharing instruction in response to a triggering operation performed to the target control, in which the sharing instruction is used to instruct to recommend the target social content to a second user account which has established an account association relationship with the first user account.

In some embodiments, the generation module 1502 is configured to:
generate a first sharing instruction in response to the triggering operation performed to the target control, in which the first sharing instruction is used to instruct to recommend the target social content to a plurality of second user accounts.

In some embodiments, the generation module 1502 is configured to:
display a first page in response to the triggering operation performed to the target control, in which the first page displays a plurality of second user accounts; and
generate a second sharing instruction in response to a selection operation performed to at least one second user account among the plurality of second user accounts, in which the second sharing instruction is used to instruct to recommend the target social content to the at least one second user account selected by the selection operation.

In some embodiments, the apparatus further includes a third display control module 1503 configured to:
display first prompt information in response to receiving the first prompt information, in which the first prompt information is used to prompt that the target social content has been viewed by a user account with an account association relationship.

In some embodiments, the apparatus further includes a fourth display control module 1504 configured to:
display second prompt information in response to receiving the second prompt information, in which the second prompt information is used to prompt that the target social content has been viewed by the second user account.

In some embodiments, the apparatus includes a fifth display control module 1505 configured to:
display third prompt information, in which the third prompt information is used to prompt that the target social content has been recommended to the second user account.

FIG. 16 is a block diagram of a social content sharing apparatus which is illustrated according to some embodiments. Referring to FIG. 16, the social content sharing apparatus is applied to a second user terminal which is a terminal device of a second user account. The social content sharing apparatus includes:
a determination module 1601 configured to determine content to be displayed in response to a content display operation; and
a second display control module 1602 configured to display target social content including type prompt information on a second page when the content to be displayed includes target social content determined according to a sharing instruction, in which the sharing instruction is generated by a first user terminal which is a terminal device of a first user account. The sharing instruction is used to instruct to recommend the target social content to the second user account. The second user account has established an account association relationship with the first user account. The type prompt information is used to prompt that the target social content is social content recommended by a user account with an account association relationship.

In some embodiments, the type prompt information carries account information of the first user account, and the type prompt information is also used to prompt that the target social content is social content recommended by the first user account.

In some embodiments, the apparatus further includes a first processing module 1603 configured to:
generate first prompt information, and send the first prompt information to the first user terminal, so that the first user terminal displays the first prompt information, in which the first prompt information is used to prompt that the target social content has been viewed by a user account with an account association relationship.

In some embodiments, the apparatus further includes a second processing module 1604 configured to:
generate second prompt information according to the second user account, and send the second prompt information to the first user terminal, so that the first user terminal displays the second prompt information, in which the second prompt information is used to prompt that the target social content has been viewed by the second user account.

Regarding the apparatuses in the above embodiments, the specific manner in which each module performs operations has been described in detail in the embodiments related to the method, and will not be described in detail here.

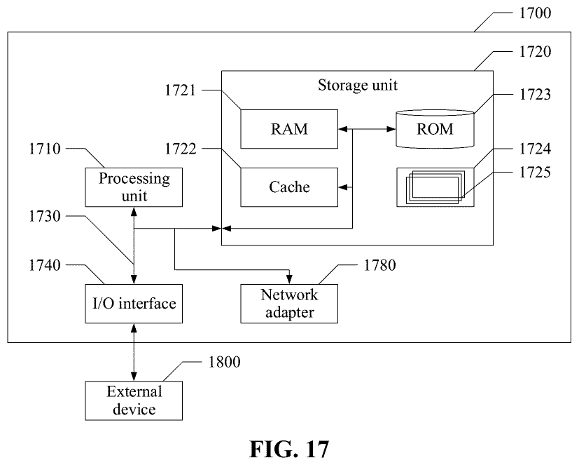

An electronic device is provided according to an exemplary embodiment of the present disclosure, which may be a terminal device. The electronic device will be described below with reference to FIG. 17. It should be understood that the electronic device 1700 shown in FIG. 17 is only an example and should not bring any limitations to the functions and scope of use of the embodiments of the present disclosure.

As shown in FIG. 17, the electronic device 1700 is embodied in the form of a general computing device. The components of the electronic device 1700 may include, but are not limited to: at least one processing unit 1710, at least one storage unit 1720, and a bus 1730 connecting different system components (including the storage unit 1720 and the processing unit 1710).

The storage unit stores program code, and the program code can be executed by the processing unit 1710, so that the processing unit 1710 performs the steps according to various exemplary embodiments of the present invention described in the “Example Method” section of this specification. For example, the processing unit 1710 may perform the method steps shown in FIGS. 2 to 5, etc.

The storage unit 1720 may include a volatile storage unit, such as a random access storage unit (RAM) 1721 and/or a cache storage unit 1722, and may further include a read-only storage unit (ROM) 1723.

The storage unit 1720 may also include a program/utility 1724 having a set of (at least one) program modules 1725 including, but not limited to: an operating system, one or more applications, other program modules, and program data. Each of these examples, or some combination, may include the implementation of a network environment.

The bus 1730 may include a data bus, an address bus, and a control bus.

The electronic device 1700 may also communicate with one or more external devices 1800 (e.g., a keyboard, a pointing device, a Bluetooth device, etc.), which communication may occur through an input/output (I/O) interface 1740. The electronic device 1700 may also communicate with one or more networks (e.g., a local area network (LAN), a wide area network (WAN), and/or a public network, such as the Internet) through a network adapter 1780. As shown, the network adapter 1780 communicates with other modules of the electronic device 1700 via the bus 1730. It should be understood that, although not shown in the figures, other hardware and/or software modules may be used in conjunction with the electronic device 1700, including but not limited to: microcode, device drivers, redundant processing units, external disk drive arrays, RAID systems, tape drives and data backup storage system, etc.

It should be noted that although several modules or units of devices for action execution are mentioned in the above detailed description, this division is not mandatory. In fact, according to exemplary embodiments of the present disclosure, the features and functions of two or more modules or units described above may be embodied in one module or unit. Conversely, the features and functions of one module or unit described above may be further divided into being embodied by multiple modules or units.

Those skilled in the art will understand that various aspects of the present disclosure may be implemented as systems, methods, or program products. Therefore, various aspects of the present disclosure may be embodied in the following forms, namely: a complete hardware implementation, a complete software implementation (including firmware, microcode, etc.), or an implementation combining hardware and software aspects, which may be collectively referred to herein as “circuit”, “module” or “system”. Other embodiments of the present disclosure will be readily apparent to those skilled in the art from consideration of the specification and practice of the invention disclosed herein. The present disclosure is intended to cover any variations, uses, or adaptations of the present disclosure that follow the general principles of the present disclosure and include common sense or customary technical means in the technical field that are not disclosed in the present disclosure. It is intended that the specification and embodiments be considered as exemplary only, with a true scope and spirit of the present disclosure being indicated by the appended claims.

In addition, the present disclosure also provides a computer-readable storage medium. When instructions in the computer-readable storage medium are executed by a processor of an electronic device, the electronic device can perform the content sharing method as provided in the above embodiments.

In addition, the present disclosure also provides a computer program product, which includes computer instructions. When the computer instructions run on an electronic device, the electronic device can perform the content sharing method as provided in the above embodiments.

Other embodiments of the present disclosure will be readily apparent to those skilled in the art from consideration of the specification and practice of the invention disclosed herein. This application is intended to cover any variations, uses, or adaptations of the present disclosure that follow the general principles of the present disclosure and include common knowledge or customary technical means in the technical field that are not disclosed in the present disclosure. It is intended that the specification and examples be considered as exemplary only, with a true scope and spirit of the present disclosure being indicated by the appended claims.

It is to be understood that the present disclosure is not limited to the precise structures described above and illustrated in the accompanying drawings, and various modifications and changes may be made without departing from the scope thereof. The scope of the present disclosure is limited only by the appended claims.

What is claimed is:

1. A content sharing method, applied to a first user terminal which is a terminal device of a first user account and is installed with a social media application, and comprising:
displaying a sharing page in response to a sharing operation performed to target social content displayed on a social content display page of the social media application, wherein the social content display page includes a content sharing control, and the sharing operation is performed by a first user on the content sharing control, wherein the sharing page comprises the target social content and a target control and wherein the target control is configured to be triggered to share social content to an associated user account; and
generating a sharing instruction in response to a triggering operation performed on the target control, wherein the sharing instruction is used to instruct to recommend the target social content to a second user account which has established an account association relationship with the first user account, and is sent to a second user terminal via a server of the social media application, wherein a second user terminal of a second user account is installed with the social media application.

2. The content sharing method according to claim 1, further comprising:
sending a relationship establishment request to a second user terminal of the second user account via the server.

3. The content sharing method according to claim 1, wherein, while the second user terminal is connected to the server, the target social content is determined as content to be displayed in the case that the server determines that a second user account has established an account association relationship with the first user account based on the first user account and account relationship information, and wherein the content to be displayed is displayed as the target social content on the second user terminal in response to a content display operation performed on the second user terminal.

4. The content sharing method according to claim 1, wherein said generating the sharing instruction in response to the triggering operation performed to the target control comprises:
generating a first sharing instruction in response to the triggering operation performed to the target control, wherein the first sharing instruction is used to instruct to recommend the target social content to a plurality of second user accounts.

5. The content sharing method according to claim 1, wherein said generating the sharing instruction in response to the triggering operation performed to the target control comprises:
displaying a first page in response to the triggering operation performed to the target control, wherein the first page displays a plurality of second user accounts; and
generating a second sharing instruction in response to a selection operation performed to at least one second user account among the plurality of second user accounts, wherein the second sharing instruction is used to instruct to recommend the target social content to the at least one second user account selected in the selection operation.

6. The content sharing method according to claim 4, further comprising:
displaying first prompt information in response to receiving the first prompt information from a user account with an account association relationship via a server, wherein the first prompt information is used to prompt that the target social content has been viewed by the user account with the account association relationship.

7. The content sharing method according to claim 5, further comprising:
displaying second prompt information in response to receiving the second prompt information from the second user account via a server, wherein the second prompt information is used to prompt that the target social content has been viewed by the second user account.

8. The content sharing method according to claim 1, comprising:
displaying, on an updated social content display page, third prompt information, wherein the third prompt information is used to prompt that the target social content has been recommended to the second user account.

9. A content sharing method, applied to a second user terminal which is a terminal device of a second user account and is installed with a social media application, and comprising:
determining content to be displayed in response to a content display operation on a social content display page of the social media application; and
displaying, on the social content display page, a target social content including type prompt information, in a case that the content to be displayed comprises the target social content determined according to a sharing instruction, wherein the sharing instruction is generated by a first user terminal which is a terminal device of a first user account, installed with the social media application and is used to instruct to recommend the target social content to the second user account which has established an account association relationship with the first user account, and the type prompt information is used to prompt that the target social content is social content recommended by a user account with account association, and wherein the sharing instruction is received from the first user terminal via a server of the social media application.

10. The content sharing method according to claim 9, further comprising displaying an acknowledge page upon receiving an establishment consent operation by a first user account, wherein the acknowledge page is configured to acknowledge successful establishment of the account association relationship.

11. The content sharing method according to claim 10, wherein the acknowledge page includes an acceptance control configured for the second user account to determine whether to receive social content recommended by the associated user account, wherein, when the acceptance control is in a turn-on state, it indicates that the second user account agrees to receive the social content recommended by the first user account, and when the acceptance control is on a turn-off state, it indicates that second user account refuses to receive the social content recommended by the first user account, and wherein the server is informed of a state of the acceptance control.

12. The content sharing method according to claim 9, wherein the server is configured to determine a second user account that has established an account association relationship with the first user account based on the first user account and account relationship information, and after determining that the second user terminal of the second user account is connected to the server, determine social content posted by a user account having an account association relationship with the second user account as the content to be displayed, and send the content to be displayed to the second user terminal, the method further comprising:
displaying the content to be displayed as the target social content in response to a content display operation, and upon determination that the content to be displayed includes the target social content according to the sharing instruction.

13. The content sharing method according to claim 12, wherein determining the content to be displayed as the target social content in response to the content display operation comprises: after the second user terminal obtains running feedback of the social media application in the second user terminal, and the running feedback is a status that the social media application is being run in the second user terminal.

14. The content sharing method according to claim 9, wherein the type prompt information carries account information of the first user account, and the type prompt information is also used to prompt that the target social content is social content recommended by the first user account.

15. The content sharing method according to claim 9, further comprising:
generating first prompt information and sending the first prompt information to the first user terminal so that the first user terminal displays the first prompt information, wherein the first prompt information is used to prompt a first user of the first user account that the target social content has been viewed by a user account with an account association relationship.

16. The content sharing method according to claim 9, further comprising:
generating second prompt information according to the second user account and sending the second prompt information to the first user terminal so that the first user terminal displays the second prompt information, wherein the second prompt information is used to prompt a first user of the first user account that the target social content has been viewed by the second user account.

17. An electronic device, comprising:
a processor;
a memory for storing instructions executable by the processor;
wherein the processor is configured to execute the instructions to perform the method defined according to claim 1.

18. An electronic device, comprising:
a processor;
a memory for storing instructions executable by the processor;
wherein the processor is configured to execute the instructions to perform the method defined according to claim 9.
